(19) United States
(12) Patent Application Publication
(10) Pub. No.: US 2008/0300123 A1
(43) Pub. Date: Dec. 4, 2008

(54) Article Handling Device

(76) Inventor: Jean-Christophe Bonnain, Chateauroux (FR)

Correspondence Address: MEADWESTVACO CORPORATION, 1021 MAIN CAMPUS DRIVE, CENTENNIAL CAMPUS, RALEIGH, NC, 27606, US

(21) Appl. No.: 12/066,549

(22) PCT Filed: Sep. 12, 2006
(86) PCT No.: PCT/US06/35451

§ 371 Date: Aug. 11, 2008

(30) Foreign Application Priority Data
Sep. 12, 2005 (GB) 0518564.0

(51) Int. Cl. B31B 1/78

(52) U.S. Cl. 493/310; 493/319

(57) ABSTRACT

A device for fully erecting a flat collapsed carton into an erected carton sleeve, the device comprising an arm linkage comprising a first arm (20a, 20b) coupled to a shaft (12), said shaft (12) being coupled to a drive means to achieve rotational movement of the arm linkage, a second arm (24a, 24b) pivotally coupled at one end to the first arm (20a, 20b) and at an opposite end further coupled to at least one suction device (16,17,18), said suction device actuated to engage a panel of a flat collapsed carton, and a third arm (22a, 22b) coupled to the shaft (12) such that the second and third arms are maintained substantially parallel to one another, the second and third arms being coupled to one another by a support arm (26a, 26b), which support arm is substantially parallel to the first arm (20a, 20b), and wherein the first and third arms are driven at different angular velocities to effect construction of a flat collapsed carton into an erected carton sleeve.

### FIELD OF INVENTION

The present invention provides a mechanism for handling articles. In particular, but not exclusively, the mechanism may be used to erect flat collapsible carton blanks so as to form a tubular structure. Alternatively, the mechanism may be used to pick and place articles from a first elevation to a second elevation.

### BACKGROUND OF INVENTION

It is well known in the packaging industry to provide cartons for packaging of articles as a flat collapsed carton sleeve which is pre-glued and pre-folded. Such cartons may then be assembled into an erected carton sleeve forming a tubular structure for loading with articles in a packaging machine. It is desirable to be able to erect carton blanks of different designs and construction and with different relative arrangements of panels using a single device.

The present invention seeks to overcomes or at least mitigate the problems of the prior art, by providing a single device adaptable for erecting a plurality of different configurations of carton, and more specifically those of use in end loading packaging machines.

Furthermore, it is desired to provide a carton erection device that is compact, in order to reduce the size of a packaging machine into which the device is incorporated.

### SUMMARY OF INVENTION

According to a first aspect of the present invention there is provided a device for fully erecting a flat collapsed carton into an erected carton sleeve, the device comprising an arm linkage comprising a first arm coupled to a shaft, said shaft being coupled to a drive means to achieve rotational movement of the arm linkage, a second arm pivotally coupled at one end to the first arm and at an opposite end further coupled to at least one suction device, said suction device actuated to engage a panel of a flat collapsed carton, and a third arm coupled to the shaft such that the second and third arms are maintained substantially parallel to one another, the second and third arms being coupled to one another by a support arm, which support arm is substantially parallel to the first arm, and wherein the first and third arms are driven at different angular velocities to effect construction of a flat collapsed carton into an erected carton sleeve.

Preferably, the angular velocities of the first and third arms changes according to a predetermined sequence during a cycle of the carton sleeve erection process.

More preferably, the predetermined sequence of angular velocity of the first and third arms is repeated to effect erection of subsequent flat carton sleeves supplied to the device by a conveyor means.

Optionally, the predetermined angular velocity sequence may be adjusted such that flat collapsed carton of different configuration or relative arrangement of panels may be erected into erected carton sleeves.

Preferably, the device comprises a plurality of arm linkages for sequentially engaging flat collapsed carton provided by the conveyor means.

More preferably, the device is capable of engaging at least two flat carton sleeves simultaneously.

Preferably, the flat collapsed cartons are in different phases of construction.

Preferably, the device is capable of erecting a flat collapsed carton wherein the top panel is disposed above and in registry with the base panel in a flat collapsed state, the device being capable of moving the suction device normal to the top panel relative to the movement of the flat carton sleeve on the conveyor means.

More preferably, the device is capable of moving the suction cup parallel to the conveyor means and at the same linear speed as that of the conveyor means.

Optionally, the device is capable of erecting a flat collapsed carton wherein the top panel is not in registry with the base panel, the device being capable of engaging the top panel and bringing it into registry with the base panel when it is an erected carton sleeve, and thereafter moving the suction up at the same linear speed as the conveyor means.

Alternatively, the erected carton sleeve is engaged by lugs on a conveyor means to be conveyed to a device for introducing articles into the erected carton sleeve.

According to a second aspect of the present invention there is provided a device for erecting successive flat collapsed cartons into erected carton sleeves for loading with product, the device comprising carton panel engaging means disposed to manipulate successive cartons in a supply stream disposed on a conveyor means, such that a successive pair of cartons is engaged and erected by a first and second panel engaging means, respectively, drawing a panel of each of said successive pair of cartons away from the conveyor means to erect the carton sleeve, the arrangement being such that the first and second engaging means are driven together whereby the first engaging means is released from a carton erected from its flat collapsed form substantially coincidentally with the manipulation of the next succeeding carton, by the second panel engaging means.

### BRIEF DESCRIPTION OF FIGURES

An exemplary embodiment of the present invention will now be described by way of example only, with reference to the accompanying drawings in which:

FIG. 1 illustrates perspective view of a carton erection device according to a preferred embodiment of the invention,

FIG. 2 illustrates perspective view of the carton erection device of FIG. 1 at a stage of partial assembly of a flat carton sleeve,

FIG. 3 illustrates perspective view of the carton erection device of FIG. 1 at a further stage in the process of carton erection of that in FIG. 2,

FIG. 4 illustrates perspective view of the carton erection device of FIG. 1 as the erected carton is engaged by a conveyor mechanism.

FIG. 5 illustrates perspective view of the carton erection device of FIG. 1 with a second carton sleeve partially erected, and

FIG. 6 illustrates perspective view of the carton erection device of FIG. 1 with two erected cartons.

### DETAILED DESCRIPTION OF THE PREFERRED EMBODIMENT

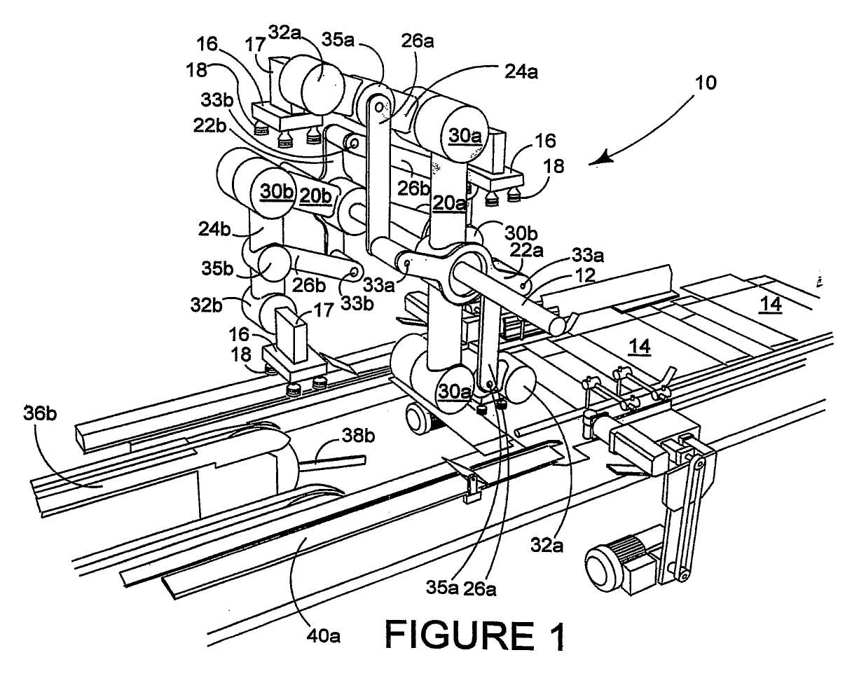

FIG. 1 illustrates a carton erection device 10 capable of erecting cartons into a tubular structure from a flat collapsed sleeve configuration.

Alternatively, it is envisaged that the present invention could be employed as an article manipulation device, picking and placing an article from one location to another, more specifically from one elevation to another.

The carton erection device 10 comprises a shaft 12; shaft 12 is coupled to a drive means, not shown, such as a servo motor, to provide rotational movement of the shaft 12.

In the preferred embodiment the notational movement is in a clockwise direction when viewed from the perspective of FIG. 1.

Shaft 12 is coupled to arms 20a, 20b 22a, 22b. Arms 20a, 20b, 22a, 22b are mounted centrally about shaft 12, such that they rotate about shaft 12. Each end 30a of arm 20a is coupled to a forearm 24a, correspondingly each end 30b of arm 20b is coupled to a forearm 24b.

Each of the four forearms 24a, 24b is coupled to its respective arm 20a or 20b such that it can pivot about its respective points 30a or 30b by which they are connected to arms 20a or 20b.

A support arm 26a is pivotally coupled at one end to each of the forearms 24a at pivot points 35a. A further support arm 26b is pivotally coupled at one end to each of forearms 24b at pivot points 35b. The opposite ends of support arms 26a are pivotally coupled to opposing ends of arm 22a, whereas the opposite ends of support arms 26b are pivotally coupled to the opposing ends of arm 22b.

The distance between connection points 35a, 35b of support arms 26a, 26b and the adjacent connection points 30a, 30b between forearms 24a, 24b and arms 20a, 20b respectively is substantially equal to the distance from the shaft 12 to the connection point of support arm 26a, 26b to arms 22a and 22b respectively. The length of support arms 26a, 26b is therefore equal to the distance measured along arms 20a, 20b from the shaft 12 to the connection points 30a, 30b. This ensures that arms 20a and 20b are maintained parallel to support arms 26a and 26b respectively, and correspondingly, that forearms 24a and 24b are maintained parallel to arms 22a and 22b respectively. Arm 20a, arm 22a, support arm 26a and forearm 24a form two vertically opposite parallelograms. Arm 20b, arm 22b, support arms 26b and forearms 24b form two vertically opposite parallelograms. Coupled to each end of each of the forearms 24a and 24b is a mounting block 17, which is configured to be pivotable about the coupling points 32a and 32b.

Attached to the mounting block 17 is a plate 16 upon which four suction cups 18 are mounted. Suction cups 18 are adapted to engage a panel of the flat collapsed sleeve 14 as a pick up means. Suction cups 18 are capable of forming a vacuum seal to engage a panel of the flat collapsed sleeve 14.

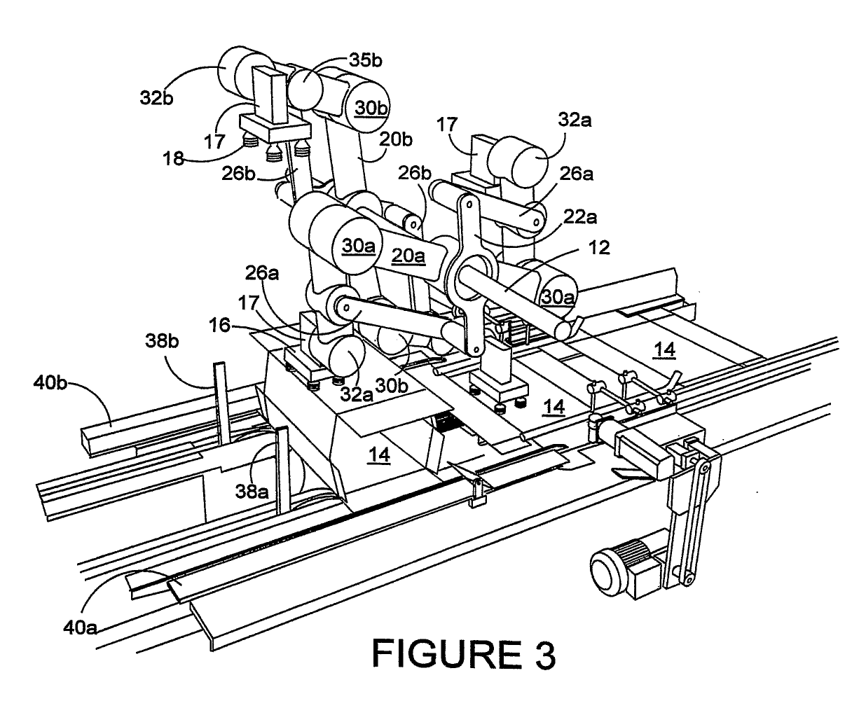

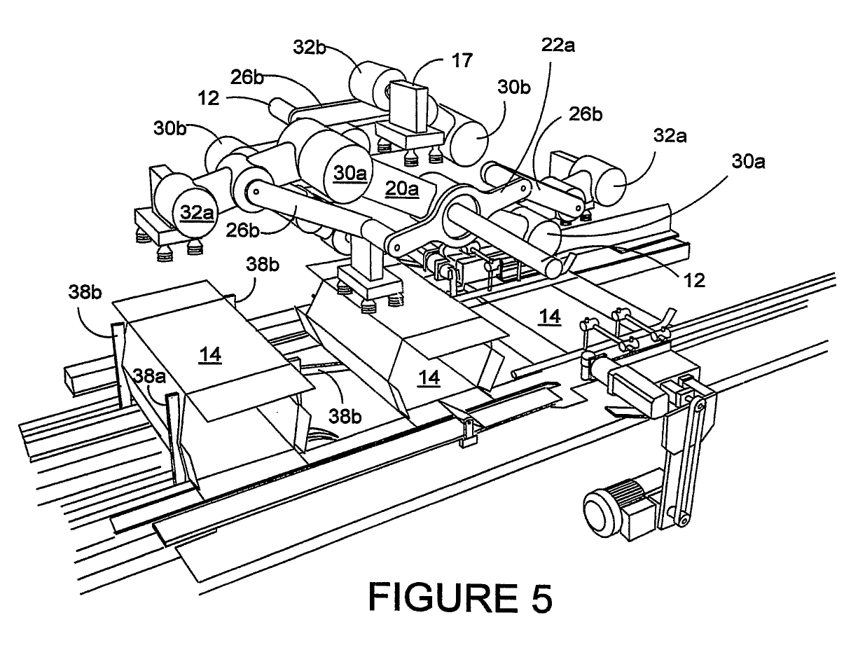

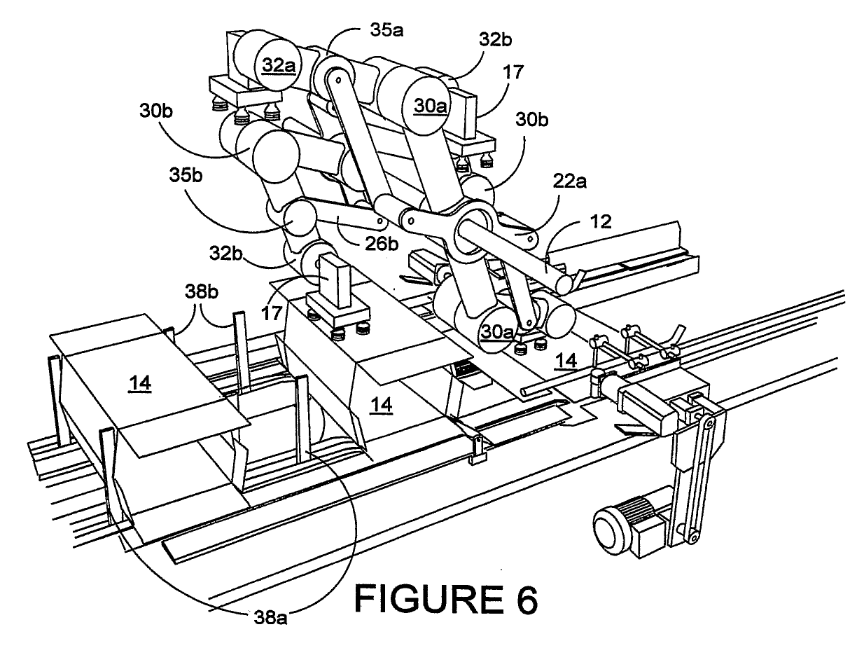

Referring to FIGS. 1 to 6, it can be seen that mounting blocks 17 are held in a substantially vertical orientation throughout the sequence of operation, such that the suction cups 18 are facing towards a conveyor mechanism (not shown) conveying the flat collapsed blanks of the packing machine throughout the entire cycle of carton 14 assembly.

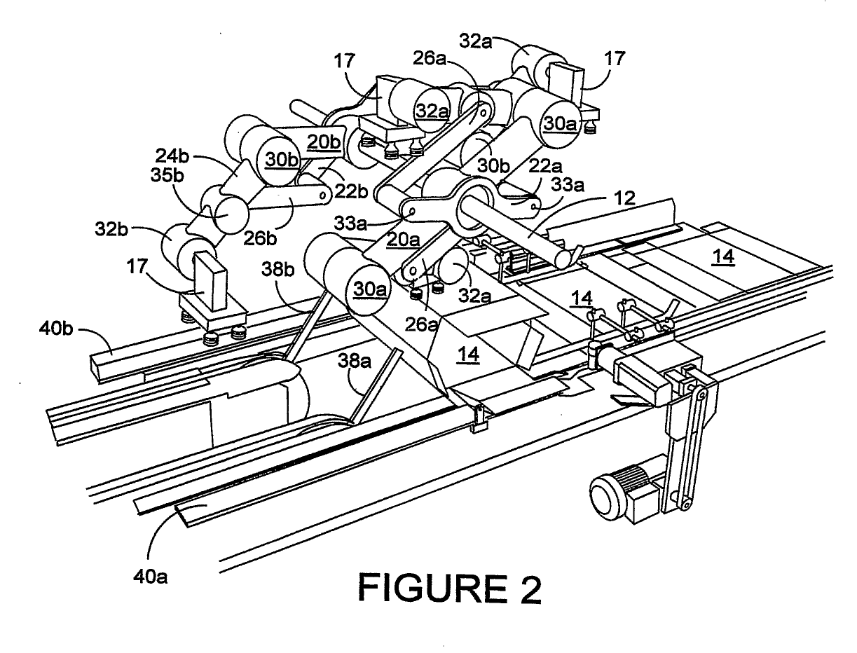

Arms 22a and 22b are maintained in a constant spaced apart parallel relationship with respect to forearms 24a and 24b. Support arms 26a and 26b are maintained in a parallel relationship with respect to arms 20a and 20b. The separation between support arms 26a, 26b and arms 20a and 20b is altered as the shaft 12 rotates, as can be seen by comparison between FIGS. 1 and 2. The angle subtended between arms 22a and 20a changes accordingly. In this way the forearms 24a, 24b can be extended to reach beyond the arms 20a, 20b or retracted within the reach of arms 20a, 20b.

The configuration of carton 14 depicted in FIGS. 1 to 6 is such that the top panel is above the base panel and in registry with the base panel when the carton 14 is in the flat collapsed sleeve 14 state. In order to erect the tubular structure 14 it is necessary to raise the top panel vertically with respect to the base panel. In order to achieve this in the preferred embodiment the angular speed of the shaft 12 is varied through the cycle of constructing the tubular structure 14 from the flat carton sleeve 14. The control of the angular speed of the shaft 12 is controlled by a control means, not shown, coupled to the drive means. The control means may be programmed to control the drive means in a predetermined sequence. The control means may store a plurality of predetermined sequences in a memory device, not shown. A predetermined sequence may be chosen from the memory device dependent upon the configuration of the carton 14 to be erected.

Rotation of arms 20a, 20b and 22a and 22b is controlled such that relative to the linear movement of the cartons 14 along the conveyor mechanism the top panel of the tubular structure 14 is raised in a vertical manner, to completely erect the tubular structure. Thereafter the suction cup 18 moves horizontally, with linear speed equal to that of the tubular structure 14, until the tubular structure 14 is engaged by lugs 38a,38b of a conveyor mechanism.

In this preferred embodiment the present invention is also capable of erecting cartons of different structures where the top panel is not located directly above and in registry with the base panel. In order to achieve erection of such structures the device 10 is capable of bringing the top panel from its start position to an erected position substantially above, and in registry with, the base panel when erected to form the tubular structure. In order to achieve this, the device 10 may require there to be an appreciable velocity between the suction cup 18 and the flat collapsed sleeve 14 as it is conveyed by the conveyor means. This is achieved by changing the predetermined sequence of the angular velocity of the shaft and the angular velocities of the arms 20a, 20b, 22a, 22b. It will be appreciated that altering the angular speed of the shaft through the cycle of carton erection, produces an effect similar to that of a cam and cam follower. The preferred embodiment is effectively an “electrical cam” this being achieved by variation of the angular speed.

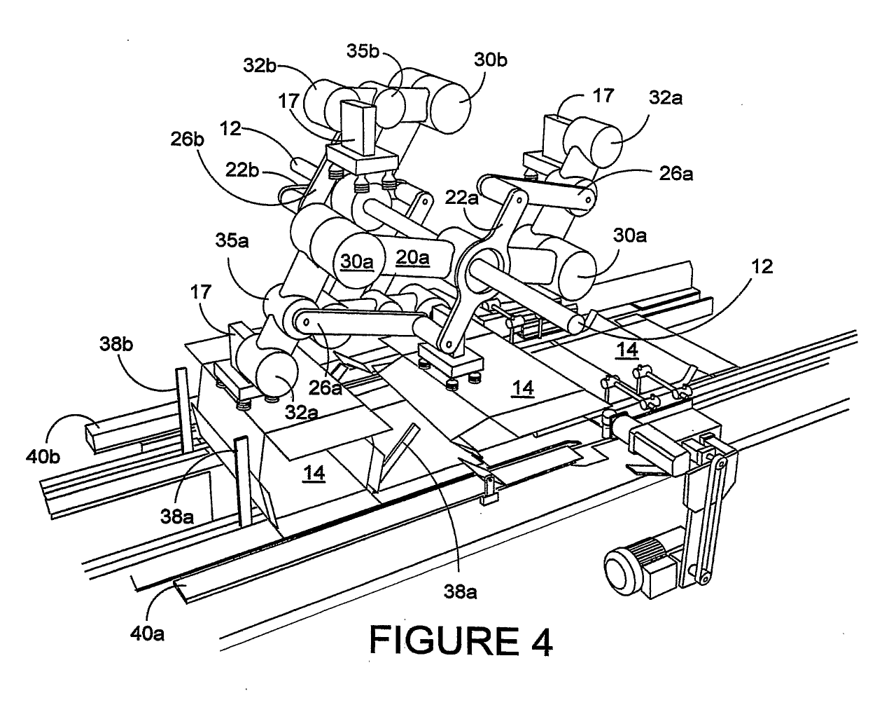

It will be appreciated that in order to prevent suction cups 18 simply raising the flat sleeve 14 above the conveyor mechanism, the base panel of the carton must be held in contact with the conveyor. This is achieved by forcing the base end panels to follow a fixed guide 40a and 40b which prevents the base panel from being raised above the conveyor means. Furthermore, as can be seen by referring to FIG. 4 of the accompanying drawings, the carton erection device 10 is capable of engaging two cartons 14 simultaneously upon independent pick up means. The first carton 14 is in a fully erected state and is engaged by lugs 38a, 38b of a conveyor mechanism whilst the second carton 14 is in a partially erect state. In order to allow carton erection device 10 to erect the carton 14 in such a manner, the angular speed of rotation of the shaft 12 can be adjusted such that it is subject to change throughout the sequence of opening a carton blank 14. The sequence may be repeatedly carried out so as to engage subsequent cartons 14.

This sequence may be adjusted such that the carton erection device 10 is capable of erecting a carton blank 14 whose structure and panel configuration is different to those shown in FIGS. 1 to 6. Control of the drive means by a control means allows a sequence to be changed depending on the carton configuration to be opened.

References to directional features such as ‘top,’ ‘bottom,’, ‘vertical’, ‘horizontal’, ‘topmost,’ ‘uppermost’ and ‘lowermost’ serve only to differentiate their respective components from one another, and should not be seen as limiting those respective components to a particular orientation; it will be understood that other embodiments may be used in which such directional features are altered without departing from the scope of the present invention.

1. A device for fully erecting a flat collapsed carton into an erected carton sleeve, the device comprising an arm linkage comprising a first arm coupled to a shaft, said shaft being coupled to a drive means to achieve rotational movement of the arm linkage, a second arm pivotally coupled at one end to the first arm and at an opposite end further coupled to at least one suction device, said suction device actuated to engage a panel of a flat collapsed carton, and a third arm coupled to the shaft such that the second and third arms are maintained substantially parallel to one another, the second and third arms being coupled to one another by a support arm, which support arm is substantially parallel to the first arm, and wherein the first and third arms are driven at different angular velocities to effect construction of a flat collapsed carton into an erected carton sleeve.

2. A device according to claim 1 wherein the angular velocities of the first and third arms changes according to a predetermined sequence during a cycle of the carton sleeve erection process.

3. A device according to claim 2 wherein the predetermined sequence of angular velocity of the first and third arms is repeated to effect erection of subsequent flat carton sleeves supplied to the device by a conveyor means.

4. A device according claim 1 wherein the predetermined angular velocity sequence may be adjusted such that a flat collapsed carton of different configuration or relative arrangement of panels may be erected into erected carton sleeves.

5. The device of claim 1 wherein the device comprises a plurality of arm linkages for sequentially engaging flat collapsed carton provided by the conveyor means.

6. A device according to claim 6 wherein the device is capable of engaging at least two flat carton sleeves simultaneously.

7. A device according to claim 7 wherein the flat collapsed cartons are in different phases of construction.

8. A device according claim 1 wherein the device is capable of erecting a flat collapsed carton wherein the top panel is disposed above and in registry with the base panel in a flat collapsed state, the device being capable of moving the suction device normal to the top panel relative to the movement of the flat carton sleeve on the conveyor means.

9. A device according to claim 8 wherein the device is capable of moving the suction cup parallel to the conveyor means and at the same linear speed as that of the conveyor means.

10. A device according to claim 1, wherein the device is capable of erecting a flat collapsed carton wherein the top panel is not in registry with the base panel, the device being capable of engaging the top panel and bringing in into registry with the base panel when it is an erected carton sleeve, and thereafter moving the suction up at the same linear speed as the conveyor means.

11. A device according claim 1 wherein the erected carton sleeve is engaged by lugs on a conveyor means to be conveyed to a device for introducing articles into the erected carton sleeve.

12. A device for erecting successive flat collapsed cartons into erected carton sleeves for loading with product, the device comprising carton panel engaging means disposed to manipulate successive cartons in a supply stream disposed on a conveyor means, such that a successive pair of cartons is engaged and erected by a first and second panel engaging means, respectively, drawing a panel of each of said successive pair of cartons away from the conveyor means to erect the carton sleeve, the arrangement being such that the first and second engaging means are driven together whereby the first engaging means is released form a carton erected from its flat collapsed form substantially coincidentally with the manipulation of the next succeeding carton, by the second panel engaging means.

13. A packaging machine incorporating the device of claims 1 or 12.
